(19) United States
(12) Patent Application Publication
(10) Pub. No.: US 2026/0044198 A1
(43) Pub. Date: Feb. 12, 2026

(54) ELECTRONIC APPARATUS CAPABLE OF FORMING TOUCH PANEL DISPLAY IN AIR, CONTROL METHOD THEREFOR, AND STORAGE MEDIUM STORING CONTROL PROGRAM THEREFOR

(71) Applicant: CANON KABUSHIKI KAISHA, Tokyo (JP)

(72) Inventor: SHINSAKU KOBAYASHI, Chiba (JP)

(21) Appl. No.: 19/268,190

(22) Filed: Jul. 14, 2025

(30) Foreign Application Priority Data
Aug. 8, 2024 (JP) 2024-131925

(51) Int. Cl. G06F 1/3234; G02B 30/56

(52) U.S. Cl. CPC G06F 1/3265; G02B 30/56; G06F 1/3284

(57) ABSTRACT

An electronic apparatus capable of switching a mode between a first mode in which power consumption is reduced and a second mode in which reduction of power consumption is released in a non-contact manner. The electronic apparatus includes a projector that projects an image to form an aerial image, a detector that detects an operation to the aerial image in the non-contact manner, a switchover operation target disposed within a detection region in which an operation to the switchover operation target is detectable by the detector, a memory device that stores instructions, and a processor that executes the instructions to switch between the first mode and the second mode when the detector detects an operation to the switchover operation target in the non-contact manner, and stop formation of the aerial image and allow detection of an operation to the switchover operation target in the first mode.

### BACKGROUND

### Field of the Technology

The present disclosure relates to an electronic apparatus capable of forming a touch panel display in the air, a control method therefor, and a storage medium storing a control program therefor.

### Description of the Related Art

An aerial display technique to project an image in the air to form an aerial display has been known. In addition, a gesture detection technique to detect a gesture of a human is known. A combination of the aerial display technique and the gesture detection technique enables to cause a touch panel display to emerge in the air.

When using the touch panel display that emerges in the air, it is not necessary to touch and operate an actual touch panel. Therefore, the use of the touch panel display that emerges in the air reduces a risk of infection between users and prevents dirt from adhering to the touch panel display even if fingers of a user are dirty. Japanese Patent Laid-Open No. 2022-117247 (JP 2022-117247A) discloses an electronic terminal that forms an aerial display and can use the aerial display as an input/output device.

If an apparatus capable of forming an aerial display continuously forms and displays the aerial display even while a user does not use, electric power is wasted accordingly. In order to reduce this wasteful power consumption, a mode is switched to a power saving mode in which the aerial display is not formed. The user switches the mode from the power saving mode to a normal mode in which the aerial display is formed by operating a button. Since the button operation is performed by pressing the button with a fingertip of the user in contact with the button, the above-described advantages of the aerial display, such as reduction in the risk of infection and prevention of adhesion of dirt, are lost.

In addition, even if mode switching is attempted using a gesture detection technique, since the aerial display is not formed in the power saving mode, a region of gesture detection is not determined, which makes it difficult to switch a mode. The electronic terminal disclosed in the above publication switches the mode to the normal mode in which the aerial display is formed when a sensor detects a person approaching the electronic terminal. However, the configuration becomes complicated because the sensor that detects a person is needed.

In addition, since the sensor detects any person approaching the electronic terminal, the mode is switched to the normal mode every time a person is detected even when the switching to the normal mode is unnecessary.

### SUMMARY

The present disclosure is directed to provide an electronic apparatus, a control method therefor, and a storage medium storing a control program therefor, which are capable of switching a mode between a first mode in which power consumption is reduced and a second mode in which reduction of power consumption is released in a non-contact manner with a simple configuration as necessary.

Accordingly, an aspect of the present invention provides an electronic apparatus including a projector that projects an image in air to form an aerial image, a detector that detects an operation to the aerial image in a non-contact manner, a switchover operation target disposed within a detection region in which an operation to the switchover operation target is detectable by the detector, a memory device that stores a set of instructions, and at least one processor that executes the set of instructions to switch between a first mode in which power consumption of the electronic apparatus is reduced and a second mode in which reduction of the power consumption is released in a case where the detector detects an operation to the switchover operation target in the non-contact manner, and stop formation of the aerial image by the projector and allow detection of an operation to the switchover operation target by the detector in the non-contact manner in the first mode.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating an example of a hardware configuration of an electronic apparatus related to a first embodiment.

FIG. 2A is a view illustrating switching between a normal mode and a power saving mode in the electronic apparatus.

FIG. 2B is a view illustrating states of a printer, a reader, an output unit, and an input unit in the normal mode and the power saving mode.

FIG. 3 is a side view showing states of the input unit and the output unit in the normal mode when viewed from a lateral side of the output unit (a display).

FIG. 4 is a side view illustrating states of the input unit and the output unit in the power saving mode when viewed from the lateral side of the output unit (the display).

FIG. 5 is a plan view illustrating states of the input unit and the output unit in the normal mode when viewed from an upper side of the output unit (the display).

FIG. 6 is a plan view illustrating states of the input unit and the output unit in the power saving mode when viewed from the upper side of the output unit (the display).

FIG. 7 is a flowchart illustrating a process executed by the electronic apparatus in the normal mode.

FIG. 8 is a flowchart illustrating a process executed by the electronic apparatus in the power saving mode.

FIG. 9A is a view illustrating switching between the normal mode and the power saving mode in an electronic apparatus related to a second embodiment.

FIG. 9B is a view illustrating states of a printer, a reader, an output unit, and an input unit in a first power saving mode and a second power saving mode.

FIG. 10 is a plan view illustrating states of the input unit and the output unit in the second power saving mode when viewed from an upper side of the output unit (a display).

FIG. 11 is a flowchart illustrating a process executed by the electronic apparatus in the normal mode.

FIG. 12 is a flowchart illustrating a process executed by the electronic apparatus in the first or second power saving mode.

### DESCRIPTION OF THE EMBODIMENTS

Hereinafter, embodiments of the present disclosure will be described in detail with reference to the attached drawings. However, configurations described in the following embodiments are merely examples, and the scope of the present disclosure is not limited by the configurations described in the embodiments. For example, each unit constituting the present disclosure can be replaced with any configuration capable of exhibiting the same function. In addition, an arbitrary constituent may be added. Any two or more configurations (features) of the embodiments can be combined.

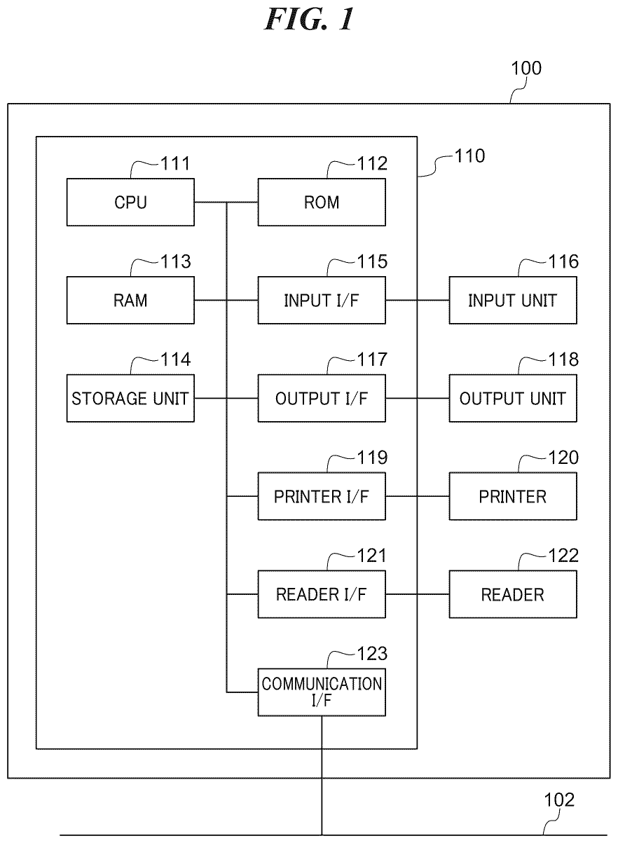

Hereinafter, a first embodiment will be described with reference to FIG. 1 to FIG. 8. FIG. 1 is a block diagram illustrating an example of a hardware configuration of an electronic apparatus related to a first embodiment. In the present embodiment, a case where the electronic apparatus is applied to an image forming apparatus will be described as an example. Note that an apparatus to which the electronic apparatus is applicable is not limited to the image forming apparatus, and may be, for example, a kiosk terminal, a medical device, or the like.

As illustrated in FIG. 1, the electronic apparatus 100 includes a controller 110, an input unit 116, an output unit 118, a printer 120, and a reader 122. The controller 110 controls operations of the entire electronic apparatus 100 (a control step). The controller 110 includes a CPU 111, a ROM 112, a RAM 113, a storage device 114, an input I/F (interface) 115, an output I/F 117, a printer I/F 119, a reader I/F 121, and a communication I/F 123.

The CPU 111 is a computer that reads control programs stored in the ROM 112 or the storage device 114 and performs various control processes, such as a reading process and a printing process. The control programs include, for example, a program to cause the CPU 111 to achieve modules or functions of the electronic apparatus 100 (a control method for the electronic apparatus). The ROM 112 stores the control programs executable by the CPU 111. In addition, the ROM 112 further stores a boot program and font data.

The RAM 113 is a main memory of the CPU 111. The RAM 113 is used as a work area or a temporary storage area to which various control programs stored in the ROM 112 and the storage device 114 are developed. The storage device 114 stores various programs and various kinds of setting information. Although a flash memory is used as the storage device 114 in the present embodiment, this is not limited. For example, an auxiliary storage device, such as an SSD, an HDD, or an eMMC, may be used as the storage device 114.

Although the controller 110 is configured so that the single CPU 111 executes the control programs using the single RAM 113 in the present embodiment, this is not limited. For example, a plurality of CPUs may execute the control programs using a plurality of memories.

The input I/F is connected to the input unit 116. The input I/F relays a control command transmitted from the CPU 111 to the input unit 116 and an input signal transmitted from the input unit 116 to the CPU 111. The input unit 116 is an aerial sensor that detects a user operation in the air, that is, a detector that detects an operation to an aerial image formed by the output unit 118 in a non-contact manner. The input unit 116 employs a sensor that specifies an XY coordinate of a point of an operation by a user on a plane using infrared rays in the present embodiment. However, the present disclosure is not limited thereto, and for example, a sensor capable of detecting a gesture of a user may be used.

The output I/F 117 is connected to the output unit 118. The CPU 111 transmits output information to the output unit 118 via the output I/F 117. The output unit 118 forms an image in the air. That is, the output unit 118 is a projector that projects an image in the air to form an aerial image.

The printer I/F 119 is connected to the printer 120. The CPU 111 transfers image data to be printed, that is, image data of a printing target, to the printer 120 via the printer I/F 119. The printer 120 prints the image data on a recording sheet fed from a sheet feeding cassette (not shown).

The reader I/F 121 is connected to the reader 122. The reader 122 reads an image on a document and converts the image data into binary data. The image data generated by the reader 122 is transmitted to an external apparatus, stored in an external recording apparatus, or printed on a recording sheet, for example. The communication I/F 123 is connected to a network 102. The communication I/F 123 transmits image data to the external apparatus and receives print data from the external apparatus via the network 102.

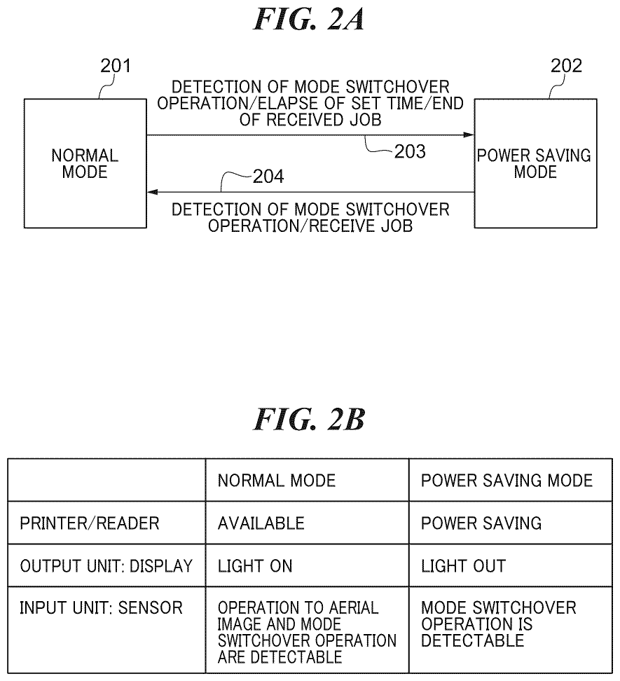

FIG. 2A is a view illustrating switching between a normal mode and a power saving mode in the electronic apparatus. As illustrated in FIG. 2A, the controller 110 control switching between a normal mode (second mode) 201 and a power saving mode (first mode) 202.

In the power saving mode 202, a power consumption of the electronic apparatus 100 is reduced. In the normal mode 201, the reduction of the power consumption of the electronic apparatus 100 is released, and the electronic apparatus 100 can accept user operations and execute various functions.

When one of the following three conditions is satisfied, the normal mode 201 is switched to the power saving mode 202 (see an arrow 203). The first condition is detection of a switchover operation to the power saving mode 202 during the normal mode 201. The second condition is detection of elapse of predetermined set time after switching to the normal mode 201. The third condition is detection of end of a job received from the outside via the communication I/F 123.

When one of the following two conditions is satisfied, the power saving mode 202 is switched to the normal mode 201 (see an arrow 204). The first condition is detection of a switchover operation to the normal mode 201 during the power saving mode 202. The second condition is detection of reception of a job from the outside via the communication I/F 123.

A time required to change the mode to the normal mode 201 from the power saving mode 202 is shorter than a time required to change a main power of the electronic apparatus 100 to an ON state from an OFF state. Accordingly, when the electronic apparatus 100 is used, the user of the electronic apparatus 100 can use the electronic apparatus 100 more easily, that is, the operability of the electronic apparatus 100 is improved, by repeating switchover between the power saving mode 202 and the normal mode 201 than by repeating switchover between the OFF state and the ON state of the main power.

FIG. 2B is a view illustrating the states of the printer, reader, output unit, and input unit in the normal mode and the power saving mode. As shown in FIG. 2B, in the normal mode 201, the printer 120 and the reader 122 are in a state in which the function can be executed more quickly than in the power saving mode 202 in response to an operation by a user (operator) who is using the electronic apparatus 100.

The output unit 118 is in a light-on state in which an image can be formed in the air, that is, an image can be projected in the air to form an aerial image. The input unit 116 is in a state in which an operation on the aerial image formed by the output unit 118 is detectable in the non-contact manner. The input unit 116 is also in a state where an operation of switching to the power saving mode 202 is detectable.

On the other hand, in the power saving mode 202, the printer 120 and the reader 122 are in a state in which the power consumption is reduced, that is, a power saving state. The output unit 118 is in a light-out state in which the formation of the aerial image is stopped. The input unit 116 is a state in which a switchover operation to the normal mode 201 is detectable.

As described above, in the normal mode 201, the input unit 116 is in the state in which the switchover operation to the power saving mode 202 is detectable. In this way, the input unit 116 is in the state in which the switchover operation to the other mode is detectable in any of the normal mode 201 and the power saving mode 202.

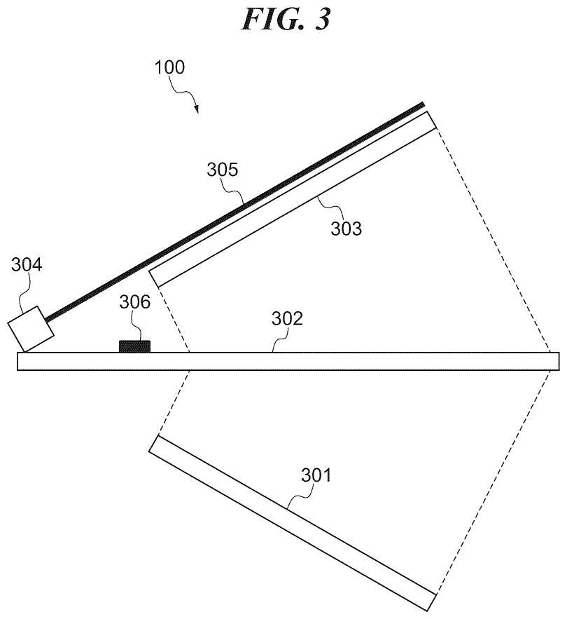

FIG. 3 is a side view showing states of the input unit and the output unit in the normal mode when viewed from a lateral side of the output unit (a display). As shown in FIG. 3, the electronic apparatus 100 includes a liquid crystal display 301, an optical element 302, a sensor 304, and a power saving key seal 306. The liquid crystal display 301 and the optical element 302 are members constituting the output unit 118. The optical element 302 has a flat plate shape and is disposed in, for example, a horizontal posture.

The liquid crystal display 301 is disposed under the optical element 302 in a posture inclined at an angle of, for example, 45 degrees with respect to the optical element 302. The liquid crystal display 301 has a backlight module (not shown) and is a display capable of displaying a signal received via the output I/F 117 as an image. The optical element 302 refracts backlight, that is, the image displayed on the liquid crystal display 301, thereby projecting the image in the air to form an aerial image 303. This enables the user to visually recognize the aerial image 303. The aerial image 303 is formed to be inclined at an angle of, for example, 45 degrees with respect to the optical element 302.

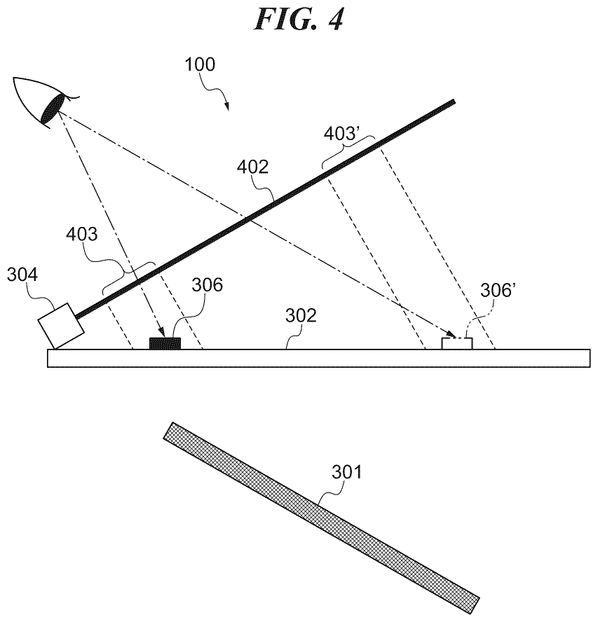

The sensor 304 is a member constituting the input unit 116, and is arranged above the optical element 302 and on the left side in FIG. 3 (the same in FIG. 4). In the present embodiment, an infrared sensor is used as the sensor 304. This enables detection of a user operation to the aerial image 303 in the non-contact manner. A sensor detection region (detection range) 305 in which a user operation is detectable with the sensor 304 is set above the aerial image 303, and is a plane parallel to the aerial image 303.

When an operation is applied to the aerial image 303, the sensor 304 detects a coordinate of an operation point (a fingertip) within the sensor detection region 305 as an operation to the aerial image 303. This detection result, i.e., the coordinate of the operation point, is transmitted to the controller 110. Then, the controller 110 can change the aerial image 303 or instruct the printer 120 or the reader 122 to start working, for example, based on the detection result.

In the configuration illustrated in FIG. 3, it is preferable that a user visually recognizes the aerial image 303 from the left side in FIG. 3 and applies an operation to the aerial image 303 from the same side. The sensor detection region 305 is formed by a plurality of infrared rays emitted from the sensor 304, and therefore, the user is difficult to visually recognize the sensor detection region 305. The size of the sensor detection region 305 can be changed by control from the controller 110. The sensor 304 is not limited to an infrared sensor.

The power saving key seal 306 is a sheet-like member attached to the upper surface of the optical element 302. The power saving key seal 306 is formed of an opaque member that does not refract light and does not allow transmission of light. Therefore, the power saving key seal 306 is preferably attached to the optical element 302 at a position that is not struck with the backlight from the liquid crystal display 301. The power saving key seal 306 serves as a mark of the switchover operation between the normal mode 201 and the power saving mode 202, that is, functions as a switchover operation target to switch between the normal mode 201 and the power saving mode 202.

The power saving key seal 306 is disposed at a position overlapping the sensor detection region 305 (within the sensor detection region 305) in a plan view of the sensor detection region 305. This enables the user to visually recognize the power saving key seal 306 through the sensor detection region 305 regardless of the states of the liquid crystal display 301 and the aerial image 303. When the sensor 304 detects a user operation to the power saving key seal 306 in the non-contact manner in the normal mode 201, the mode is switched to the power saving mode 202.

When the user operation is performed to the power saving key seal 306, the sensor 304 can detect the coordinate of the operation point within the sensor detection region 305 as the operation to the power saving key seal 306. The detection result (the coordinate of the operation point) is transmitted to the controller 110. Then, the controller 110 controls to switch the mode from the normal mode 201 to the power saving mode 202 on the basis of the detection result. Such control is also applied to control to switch the mode from the power saving mode 202 to the normal mode 201.

Although the power saving key seal 306 is the sheet-like member in the present embodiment, this is not limited. For example, a marker printed on the upper surface of the optical element 302 may be used instead of the power saving key seal 306.

FIG. 4 is a side view illustrating states of the input unit and the output unit in the power saving mode when viewed from the side of the output unit (display). The liquid crystal display 301 is in the light-out state. This stops the formation of the aerial image 303.

A sensor detection region 402 of the sensor 304 may be the same size as the sensor detection region 305 in the normal mode 201 or may be smaller than the sensor detection region 305. When the sensor detection region 402 is smaller than the sensor detection region 305, the power consumption in the sensor 304 can be reduced. When the sensor 304 detects a user operation to the power saving key seal 306 in the non-contact manner in the power saving mode 202, the mode is switched to the normal mode 201.

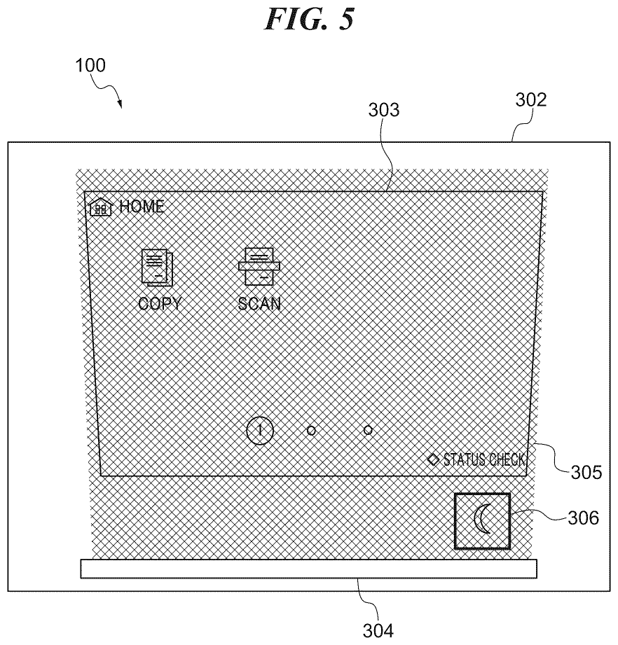

FIG. 5 is a plan view illustrating states of the input unit and the output unit in the normal mode when viewed from an upper side of the output unit (the display). As illustrated in FIG. 5, the sensor detection region 305 overlaps the aerial image 303 including a plurality of icons, and contains the aerial image 303. Accordingly, as described above, when an operation is performed to the aerial image 303, the coordinate of the operation point within the sensor detection region 305 is detected by the sensor 304 as an operation to the aerial image 303.

The power saving key seal 306 is located within the sensor detection region 305, but is arranged at a position not overlapping the aerial image 303. This enables the sensor 304 to distinguishably detect an operation to the aerial image 303 and an operation to the power saving key seal 306.

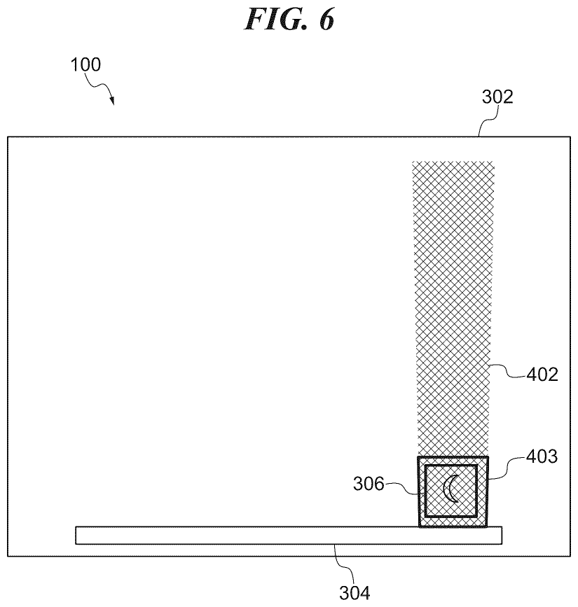

FIG. 6 is a plan view illustrating states of the input unit and the output unit in the power saving mode when viewed from the upper side of the output unit (the display). As illustrated in FIG. 6, the length of the sensor detection region 402 in the horizontal direction is shorter than the length of the sensor detection region 305 in the horizontal direction. This enables to reduce the number of the infrared rays emitted from the sensor 304 and thus to reduce the power consumption.

Although the length of the sensor detection region 402 in the vertical direction is the same as the length of the sensor detection region 305 in the vertical direction in the present embodiment, this is not limited. The power saving key seal 306 is located within the sensor sensing region 402. As described above, in the normal mode 201, the power saving key seal 306 is located within the sensor detection region 305. Accordingly, the sensor 304 can detect an operation to the power saving key seal 306 in the non-contact manner in either of the normal mode 201 or the power saving mode 202.

Hereinafter, a region that faces and includes the power saving key seal 306 within the sensor detection region 402 is referred to as a seal detection region 403. In the seal detection region 403, an operation to the power saving key seal 306 can be detected more reliably.

As described above, since the sensor detection region 305 and the sensor detection region 402 are defined independently in the electronic apparatus 100, the operation to switch the mode between the normal mode 201 and the power saving mode 202 can be detected as necessary, that is, when the user wants to switch the mode. In addition, the operation to switch the mode can be detected in the non-contact manner with a simple configuration using the sensor 304 (infrared sensor) in the electronic apparatus 100.

Here, the arrangement position of the power saving key seal 306 will be described with reference to FIG. 4. As described above, the power saving key seal 306 is disposed on the upper side of the optical element 302 and on the left side in FIG. 4. Specifically, the power saving key seal 306 is arranged at a position close to the side of the user who performs an operation to the power saving key seal 306 in the plan view of the sensor detection region 402. Thus, when the user visually recognizes the power saving key seal 306, the power saving key seal 306 is viewed in close to and overlapping with the seal detection region 403 on a line of sight. In this state, when the user operates the power saving key seal 306, the operation is likely included in the seal detection region 403, and as a result, the operation can be detected by the sensor 304.

In contrast, a case where a power saving key seal 306′ is arranged at a position (back side) far from the user, that is, on the right side in FIG. 4 is considered. A seal detection region 403′ faces and includes the power saving key seal 306′ in the sensor detection area 402. In the seal detection region 403′, an operation to the power saving key seal 306′ can be detected more reliably.

When the power saving key seal 306′ is arranged on the right side in FIG. 4 and when the user visually recognizes the power saving key seal 306′, the power saving key seal 306′ and the seal detection region 403′ do not overlap each other on the line of sight, and are apart from each other. Even if the user operates the power saving key seal 306′ in this state, the operation point is hardly included in the seal detection region 403′, and as a result, it is difficult to detect the operation with the sensor 304. Therefore, the power-saving key seal 306 is preferably disposed at a position close to the user side.

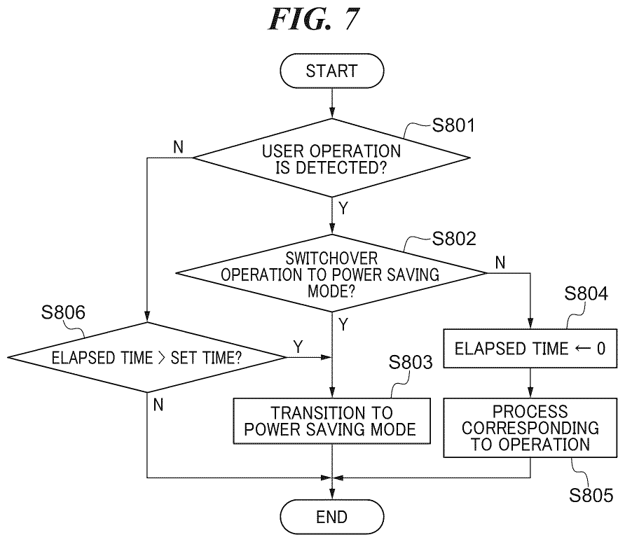

FIG. 7 is a flowchart illustrating a process executed by the electronic apparatus in the normal mode. The process (program) illustrated in FIG. 7 is periodically executed by the controller 110 during the normal mode 201. As illustrated in FIG. 7, the controller 110 determines in a step S801 whether the input unit 116 detects a user operation. As a result of the determination in the step S801, when it is determined that the user operation is detected, the process proceeds to a step S802. On the other hand, as a result of the determination in the step S801, when it is determined that no user operation is detected, the process proceeds to a step S806.

In the step S802, the controller 110 determines whether the user operation detected in the step S801 is a switchover operation to the power saving mode 202. As a result of the determination in the step S802, when it is determined that the operation is the switchover operation to the power saving mode 202, the process proceeds to a step S803. On the other hand, as a result of the determination in the step S802, when it is determined that the operation is not the switchover operation to the power saving mode 202, the process proceeds to a step S804.

In the step S803, the controller 110 switches (transitions) to the power saving mode 202. After the step S803 is executed, the process is terminated.

In the step S804, the controller 110 resets a timer of elapsed time since the input unit 116 detected the user operation last time to “0”. After the step S804 is executed, the process proceeds to a step S805.

In the step S805, the controller 110 determines the user operation detected in the step S801 and executes a process corresponding to the user operation. After the step S805 is executed, the process is terminated.

In the step S806, the controller 110 determines whether the elapsed time since the input unit 116 detected the user operation last time exceeds a predetermined set time (time until the mode is automatically switched to the power saving mode 202). As a result of the determination in the step S806, when it is determined that the elapsed time exceeds the set time, the process exceeds to the step S803. On the other hand, as a result of the determination in the step S806, when it is determined that the elapsed time does not exceed the set time, the process ends.

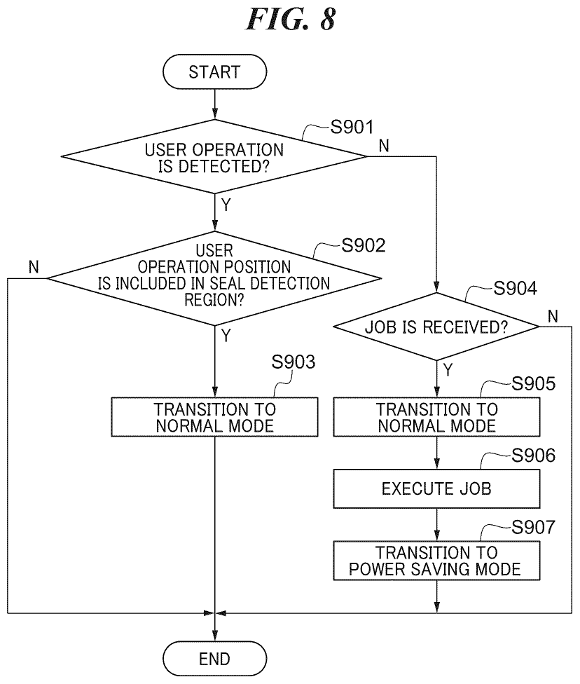

FIG. 8 is a flowchart illustrating a process executed by the electronic apparatus in the power saving mode. The process (program) illustrated in FIG. 8 is periodically executed by the controller 110 during the power saving mode 202. As illustrated in FIG. 8, the controller 110 determines in a step S901 whether the input unit 116 detects a user operation. As a result of the determination in the step S901, when it is determined that the user operation is detected, the process proceeds to a step S902. On the other hand, as a result of the determination in the step S901, when it is determined that no user operation is detected, the process proceeds to a step S904.

In the step S902, the controller 110 determines whether the coordinate of the user operation position detected in the step S901 is included in the seal detection region 403. As a result of the determination in the step S902, if it is determined that the user operation position is included in the seal detection region 403, the process proceeds to a step S903. On the other hand, as a result of the determination in the step S902, when it is determined that the user operation position is not included in the seal detection region 403, the process ends.

In the step S903, the controller 110 switches the mode to the normal mode 201. After the step S903 is executed, the process is terminated.

In the step S904, the controller 110 determines whether a job from the outside is received via the communication I/F 123, that is, whether there is a job from the outside. As a result of the determination in the step S904, when it is determined that a job is received, the process proceeds to a step S905. On the other hand, as a result of the determination in the step S904, when it is determined that no job is received, the process ends.

In the step S905, the controller 110 switches the mode to the normal mode 201. After the step S905 is executed, the process proceeds to a step S906.

In the step S906, the controller 110 discriminates the job determined in the step S904 and executes the job. The execution of the job is not particularly limited, and for example, the job is execution of printing by controlling the printer 120. After the step S906 is executed, the process proceeds to a step S907.

In the step S907, the controller 110 switches the mode to the power saving mode 202. After the step S907 is executed, the process is terminated.

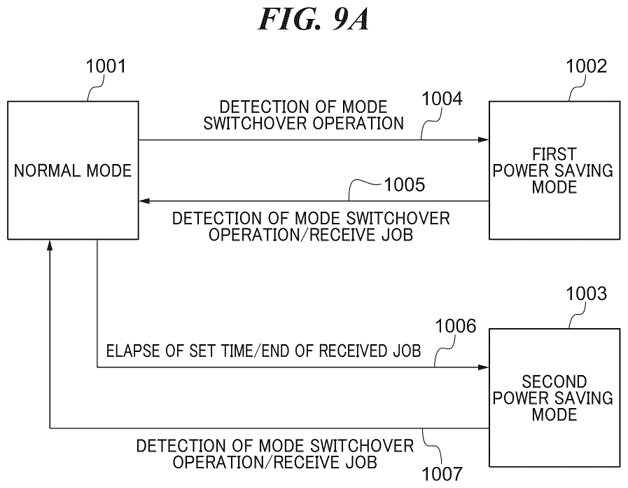

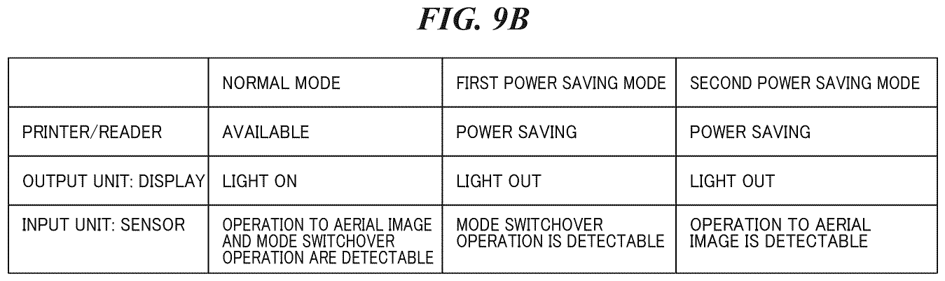

Hereinafter, a second embodiment will be described with reference to FIG. 9A to FIG. 12. Differences from the above-described embodiment will be mainly described, and the description of the same matters will be omitted. FIG. 9A is a view illustrating switching between the normal mode and the power saving mode in an electronic apparatus related to a second embodiment.

As illustrated in FIG. 9A, the controller 110 controls switching between a normal mode 1001 and a first power saving mode 1002 and controls switching between the normal mode 1001 and a second power saving mode 1003. In the normal mode 1001, similarly to the normal mode 201, the reduction of the power consumption in the electronic apparatus 100 is released, and the electronic apparatus 100 can accept user operations and execute various functions. The first power saving mode 1002 and the second power saving mode 1003 are modes in which power consumption of the electronic apparatus 100 is reduced, but are different in a size of detection region.

The mode is switched from the normal mode 1001 to the first power saving mode 1002 (see an arrow 1004) when a switchover operation to the first power saving mode 1002 is detected during the normal mode 1001. The mode is switched from the first power saving mode 1002 to the normal mode 1001 (see an arrow 1005) when one of the following two conditions is satisfied. The first condition is detection of a switchover operation to the normal mode 1001 during the first power saving mode 1002. The second condition is detection of reception of a job from the outside via the communication I/F 123.

The mode is switched from the normal mode 1001 to the second power saving mode 1003 (see an arrow 1006) when one of the following two conditions is satisfied. The first condition is detection of elapse of predetermined set time after switching to the normal mode 201. The second condition is detection of end of a job received from the outside via the communication I/F 123.

The mode is switched from the second power saving mode 1003 to the normal mode 1001 (see an arrow 1007) when one of the following two conditions is satisfied. The first condition is detection of a switchover operation to the normal mode 1001 during the second power saving mode 1003. The second condition is detection of reception of a job from the outside via the communication I/F 123.

FIG. 9B is a view illustrating the states of the printer, reader, output unit, and input unit in the normal mode, the first power saving mode, and the second power saving mode. As illustrated in FIG. 9B, in the normal mode 1001, similarly to the normal mode 201, the printer 120 and the reader 122 are in a state in which functions are executable. The output unit 118 is in the light-on state in which an aerial image can be formed. The input unit 116 is in a state in which an operation to an aerial image is detectable in the non-contact manner and the switchover operation to the first power saving mode 1002 or the second power saving mode 1003 is detectable.

On the other hand, in the first power saving mode 1002 and the second power saving mode 1003, the printer 120 and the reader 122 are in the power saving state and the output unit 118 is in the light-out state in which the formation of the aerial image is stopped, similarly to the power saving mode 202.

In the first power saving mode 1002, the input unit 116 is in a state in which the switchover operation to the normal mode 1001 is detectable. The sensor detection region 402 (see FIG. 6) including the seal detection region 403 is set in the first power saving mode 1002 as the detection region of the sensor 304.

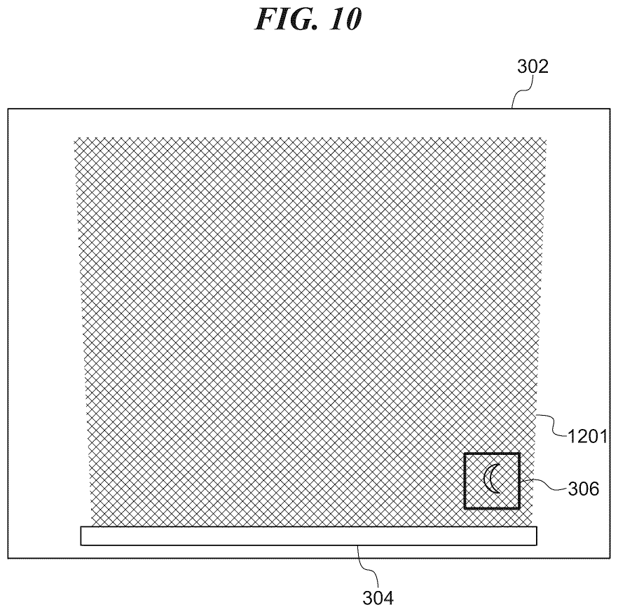

In the second power saving mode 1003, the input unit 116 is in a state in which an operation to an aerial image is detectable. In the second power saving mode 1003, a sensor detection region 1201 (see FIG. 10) is set as the detection region of the sensor 304. The sensor detection region 1201 is similar to the sensor detection region 305 (see FIG. 5).

As described above, in the present embodiment, the power saving modes includes two types of modes, namely, the first power saving mode 1002 and the second power saving mode 1003. The first power saving mode 1002 and the second power saving mode 1003 are different in the size of the sensor detection region in detecting an operation to the aerial image or the power saving key seal 306.

Specifically, the first power saving mode 1002 is a small detection region mode in which the small sensor detection region 402 is set. The second power saving mode 1003 is a large detection region mode in which the large sensor detection region 1201 is set.

FIG. 10 is a plan view illustrating states of the input unit and the output unit in the second power saving mode when viewed from the upper side of the output unit (the display). As shown in FIG. 10 and FIG. 5, the sensor detection region 1201 is equivalent to the sensor detection region 305. The entire area of the sensor detection region 1201 is used as a switchover operation region to the normal mode 1001. A region other than the seal detection region 403 in a part of the sensor detection region 1201 may be used as the switchover operation region to the normal mode 1001.

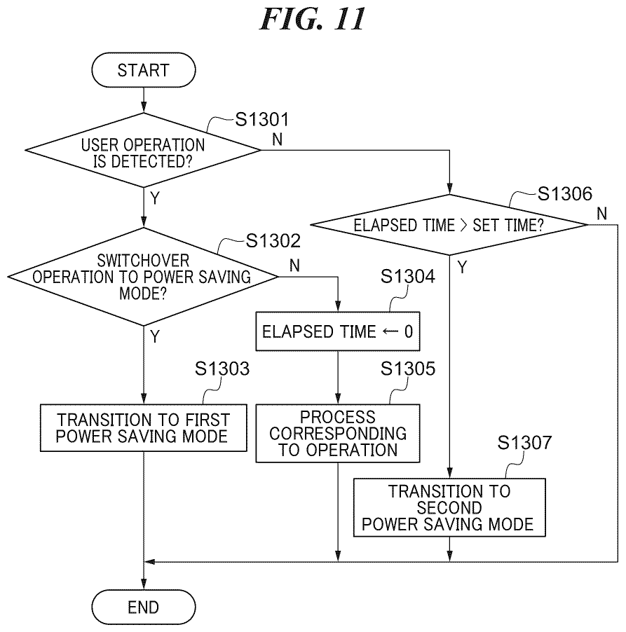

FIG. 11 is a flowchart illustrating a process executed by the electronic apparatus in the normal mode. A process (program) illustrated in FIG. 11 is periodically executed by the controller 110 during the normal mode 1001. As illustrated in FIG. 11, the controller 110 determines in a step S1301 whether the input unit 116 detects a user operation.

As a result of the determination in step S1301, when it is determined that user operation is detected, the process proceeds to step S1302. On the other hand, as a result of the determination in step S1301, when it is determined that user operation is not detected, the process proceeds to step S1306.

In the step S1302, the controller 110 determines whether the user operation detected in the step S1301 is a switchover operation to the power saving mode. As a result of the determination in the step S1302, when it is determined that the operation is the switchover operation to the power saving mode, the process proceeds to a step S1303. On the other hand, as a result of the determination in the step S1302, when it is determined that the operation is not the switchover operation to the power saving mode, the process proceeds to a step S1304.

In the step S1303, the controller 110 switches the mode to the first power saving mode 1002. After the step S1303 is executed, the process is terminated.

In the step S1304, the controller 110 resets a timer of elapsed time since the input unit 116 detected the user operation last time to “0”. After the step S1304 is executed, the process proceeds to a step S1305.

In step S1305, the controller 110 determines the user operation detected in step S1301 and executes a process according to the user operation. After the step S1305 is executed, the process is terminated.

In the step S1306, the controller 110 determines whether the elapsed time since the input unit 116 detected the user operation last time exceeds a predetermined set time (time until the mode is automatically switched to the power saving mode). As a result of the determination in the step S1306, when it is determined that the elapsed time exceeds the set time, the process exceeds to a step S1307. On the other hand, as a result of the determination in the step S1306, when it is determined that the elapsed time does not exceed the set time, the process ends.

In the step S1307, the controller 110 switches the mode to the second power saving mode 1003. After the step S1307 is executed, the process is terminated.

As described above, in the present embodiment, when the input unit 116 detects an operation to the power saving key seal 306 in the normal mode 1001, the controller 110 switches the mode to the first power saving mode 1002 (the small detection region mode). In addition, when the set time lapses after the mode is switched to the normal mode 1001, the controller 110 switches the mode to the second power saving mode 1003 (the large detection region mode).

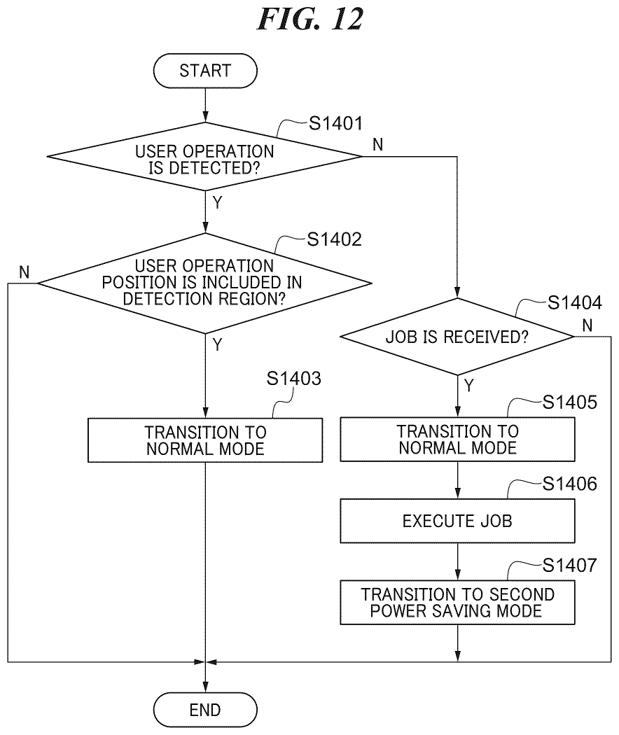

FIG. 12 is a flowchart illustrating a process executed by the electronic apparatus in the power saving mode. A process (program) illustrated in FIG. 12 is periodically executed by the controller 110 during the first power saving mode 1002 or the second power saving mode 1003. As illustrated in FIG. 12, the controller 110 determines in a step S1401 whether the input unit 116 detects a user operation.

As a result of the determination in the step S1401, when it is determined that the user operation is detected, the process proceeds to a step S1402. On the other hand, as a result of the determination in the step S1401, when it is determined that no user operation is detected, the process proceeds to a step S1404.

In step S1402, the controller 110 determines whether the coordinate of the user operation position detected in the step S1401 is included in the detection region. As a result of the determination in the step S1402, if it is determined that the user operation position is included in the detection region, the process proceeds to a step S1403. On the other hand, as a result of the determination in the step S1402, when it is determined that the user operation position is not included in the detection region, the process ends.

In the step S1403, the controller 110 switches the mode to the normal mode 1001. After the step S1403 is executed, the process is terminated.

In the step S1404, the controller 110 determines whether a job from the outside is received via the communication I/F 123. As a result of the determination in the step S1404, when it is determined that a job is received, the process proceeds to a step S1405. On the other hand, as a result of the determination in the step S1404, when it is determined that no job is received, the process ends.

In the step S1405, the controller 110 switches the mode to the normal mode 1001. After the step S1405 is executed, the process proceeds to a step S1406.

In the step S1406, the controller 110 discriminates the job determined in the step S1404 and executes the job. After the step S1406 is executed, the process proceeds to a step S1407.

In the step S1407, the controller 110 switches the mode to the second power saving mode 1003. After the step S1407 is executed, the process is terminated.

As described above, in the present embodiment, the size of the detection area of the switchover operation to the normal mode is changed depending on the condition of the transition to the power saving mode. Accordingly, when the electronic apparatus 100 automatically enters the power saving mode regardless of user's intention, the electronic apparatus 100 can be quickly returned to the normal mode by a simple operation (by widening the detection area).

On the other hand, when the electronic apparatus 100 actively enters the power saving mode in accordance with the user's intention, it is assumed that the electronic apparatus 100 is not used in the normal mode for the time being, and thus the electronic apparatus 100 waits for the return to the normal mode while narrowing the detection region in order to prevent an erroneous operation. By narrowing the detection region, the power consumption can be reduced.

When a print job is entered during the power saving mode, the mode is returned to the normal mode and the print job is executed. After this execution, the electronic apparatus 100 enters the power saving mode again. In this case, the detection region is narrowed. This is because if the detection region is not narrowed, for example, the behavior of going for the printed matter obtained by executing the print job may be erroneously detected as the switchover operation to the normal mode, and the electronic apparatus 100 may erroneously return to the normal mode.

Although the embodiments of the present disclosure have been described above, the present disclosure is not limited to the above-described embodiments, and various modifications and changes can be made within the scope of the gist of the present disclosure. As described above, the electronic apparatus can detect the mode switchover operation in the non-contact manner regardless of whether the mode is the normal mode or the power saving mode. Therefore, there is a case where the electronic apparatus 100 does not need to return from the power saving mode to the normal mode. Such a case is not particularly limited, and examples thereof include a case of switching to a maintenance mode in which maintenance on the electronic apparatus is possible.

According to the present disclosure, the switchover operation between the first mode in which power consumption is reduced and the second mode in which the reduction of the power consumption is released with a simple configuration in the non-contact manner as needed.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-131925, filed Aug. 8, 2024 which is hereby incorporated by reference herein in its entirety.

What is claimed is:

1. An electronic apparatus comprising:
a projector that projects an image in air to form an aerial image;
a detector that detects an operation to the aerial image in a non-contact manner;
a switchover operation target disposed within a detection region in which an operation to the switchover operation target is detectable by the detector;
a memory device that stores a set of instructions; and
at least one processor that executes the set of instructions to:
switch between a first mode in which power consumption of the electronic apparatus is reduced and a second mode in which reduction of the power consumption is released in a case where the detector detects an operation to the switchover operation target in the non-contact manner; and
stop formation of the aerial image by the projector and allow detection of an operation to the switchover operation target by the detector in the non-contact manner in the first mode.

2. The electronic apparatus according to claim 1, wherein the at least one processor executes instructions in the memory device to switch to the second mode in a case where the detector detects an operation to the switchover operation target in the first mode.

3. The electronic apparatus according to claim 1, wherein the at least one processor executes, in the second mode, instructions in the memory device to:
form the aerial image by the projector; and
allow detection of an operation to the aerial image and an operation to the switchover operation target by the detector.

4. The electronic apparatus according to claim 3, wherein the at least one processor executes instructions in the memory device to switch to the first mode in a case where the detector detects an operation to the switchover operation target in the second mode.

5. The electronic apparatus according to claim 3, wherein the at least one processor executes instructions in the memory device to switch to the first mode in a case where the detector does not detect an operation to the switchover operation target in the second mode and a predetermined set time elapses after switching to the second mode.

6. The electronic apparatus according to claim 1, wherein the detector includes an infrared sensor having the detection region that is a plane parallel to the aerial image.

7. The electronic apparatus according to claim 6, wherein the infrared sensor detects, when the aerial image is operated, a coordinate of an operation point within the detection region as an operation to the aerial image, and detect, when the switchover operation target is operated in the plane, a coordinate of an operation point within the detection region as an operation to the switchover operation target.

8. The electronic apparatus according to claim 6, wherein the at least one processor executes instructions in the memory device to control the infrared sensor to change a size of the detection range.

9. The electronic apparatus according to claim 8, wherein the first mode includes a large detection region mode in which the detection region when an operation to the switchover operation target is detected is large, and a small detection region mode in which the detection range is small.

10. The electronic apparatus according to claim 9, wherein the at least one processor executes instructions in the memory device to:
switch to the small detection region mode when the detector detects an operation to the switchover operation target in the second mode; and
switch to the large detection region mode when a predetermined set time elapses after switching to the second mode.

11. The electronic apparatus according to claim 6, wherein the switchover operation target is disposed at a position overlapping the detection region in a plan view of the detection region, and is visually recognized through the detection region by an operator who performs an operation to the switchover operation target.

12. The electronic apparatus according to claim 11, wherein the switchover operation target is a sheet-like member.

13. The electronic apparatus according to claim 12, wherein the sheet-like member is disposed at a position close to a side of the operator in a plan view of the detection region.

14. The electronic apparatus according to claim 1, wherein the projector includes a display that displays the image and is capable of projecting the image displayed on the display into the air by refracting the image to form the aerial image.

15. An electronic apparatus comprising:
a projector that projects an image in air to form an aerial image;
a detector that detects an operation to the aerial image in a non-contact manner;
a switchover operation target disposed within a detection region in which an operation to the switchover operation target is detectable by the detector;
a memory device that stores a set of instructions; and
at least one processor that executes the set of instructions to:
switch between a first mode in which power consumption of the electronic apparatus is reduced and a second mode in which reduction of the power consumption is released when the detector detects an operation to the switchover operation target in the non-contact manner; and
allow detection of an operation to the switchover operation target by the detector in a non-contact manner in either of the first mode and the second mode.

16. A control method for an electronic apparatus including a projector that projects an image in the air to form an aerial image, a detector that detects an operation on the aerial image in a non-contact manner, and a switchover operation target disposed within a detection region in which an operation to the switchover operation target is detectable by the detector, the control method comprising:
switching between a first mode in which power consumption of the electronic apparatus is reduced and a second mode in which reduction of the power consumption is released when the detector detects an operation to the switchover operation target in the non-contact manner; and
stopping formation of the aerial image by the projector and allow detection of an operation to the switchover operation target by the detector in the non-contact manner in the first mode.

17. A non-transitory computer-readable storage medium storing a control program causing a computer to execute a control method comprising: electronic apparatus, the control method comprising: a projector that projects an image to form an aerial image; a detector that detects an operation on the aerial image in a non-contact manner; and a switching operation target that is arranged within a detection range in which an operation on the switching operation target is detectable by the detector
switching between a first mode in which power consumption of the electronic apparatus is reduced and a second mode in which reduction of the power consumption is released when the detector detects an operation to the switchover operation target in the non-contact manner; and
stopping formation of the aerial image by the projector and allow detection of an operation to the switchover operation target by the detector in the non-contact manner in the first mode.
